(19) United States
(12) Patent Application Publication
(10) Pub. No.: US 2014/0044030 A1
(43) Pub. Date: Feb. 13, 2014

(54) SYSTEM AND METHOD OF IMPROVING STANDBY TIME IN M2M DEVICES

(71) Applicant: QUALCOMM Incorporated, San Diego, CA (US)

(72) Inventor: Shyamal RAMACHANDRAN, San Diego, CA (US)

(73) Assignee: QUALCOMM Incorporated, San Diego, CA (US)

(21) Appl. No.: 13/962,902

(22) Filed: Aug. 8, 2013

Related U.S. Application Data
(60) Provisional application No. 61/682,181, filed on Aug. 10, 2012.

(51) Int. Cl. H04W 52/02

(52) U.S. Cl. CPC H04W 52/0235
USPC 370/311

(57) ABSTRACT

A method for wireless communication includes receiving a signaling message from a wireless communication network. The signaling message includes a session interval and a device connection state indicator. The method also includes determining a device connection state based on the device connection state indicator. The method further includes transitioning to the device connection state for a time period corresponding to the session interval.

### CROSS-REFERENCE TO RELATED APPLICATION

This application claims the benefit under 35 U.S.C. §119(e) to U.S. Provisional Patent Application No. 61/682,181 entitled “SYSTEM AND METHOD OF IMPROVING STANDBY TIME IN M2M DEVICES,” filed on Aug. 10, 2012, the disclosure of which is expressly incorporated by reference herein in its entirety.

### BACKGROUND

1. Field

Aspects of the present disclosure relate generally to wireless communication systems, and more particularly to improving the standby time and resource usage of Machine-to-Machine (M2M) devices.

2. Background

M2M communication and Machine Type Communication (MTC) refer to data communication technologies used by automated devices that communicate with each other without human intervention. For example, M2M and/or MTC may refer to communications from devices that integrate sensors or meters to measure or capture information. The devices may relay that information to a central server or application. An MTC device described in aspects of the present disclosure may refer to an M2M device, an MTC device, and/or an MTC user equipment (UE), etc.

MTC devices may be used for various applications. For example, MTC devices may collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and/or transaction-based business charging.

MTC devices may use a variety of wired and/or wireless communication technologies. For example, MTC devices may communicate with a network via various wireless cellular technologies and/or various wireless networking technologies (e.g., IEEE 802.11 (Wi-Fi), IEEE 802.16 (WiMAX), etc.) MTC devices may also communicate with one another using various peer-to-peer technologies such as Bluetooth™, ZigBee™, and/or other ad-hoc or mesh network technologies. The expansion of multiple access wireless networks has improved MTC communication capabilities and decreased the amount of power and time specified for the communication of information between machines.

Applications specified for MTC devices may depend on battery power for collecting data, transmitting data, and/or receiving data. For MTC devices, reducing power consumption may prolong the time that the MTC device can operate in the field without battery replacement. Further, it may be difficult, if not impossible, to replace or recharge batteries for some MTC devices. Moreover, the volume of MTC devices registering and accessing the network may be greater than the number of traditional or human to human (H2H) devices supported by the network. Therefore, it may be desirable to improve the management of wireless cellular network resources (e.g., air interface capacity, identifier space, and/or IP address space) for MTC devices.

### SUMMARY

In one aspect of the present disclosure, a method of wireless communication is disclosed. The method includes receiving a signaling message from a wireless communication network. The signaling message includes a session interval and a device connection state indicator. The method also includes determining a device connection state based on the device connection state indicator. The method further includes transitioning to the device connection state for a time period corresponding to the session interval.

Another aspect of the present disclosure is directed to an apparatus including means for receiving a signaling message from a wireless communication network. The signaling message includes a session interval and a device connection state indicator. The apparatus also includes means for determining a device connection state based on the device connection state indicator. The apparatus further includes means for transitioning to the device connection state for a time period corresponding to the session interval.

In another aspect of the present disclosure, a computer program product for wireless communications in a wireless network having a non-transitory computer-readable medium is disclosed. The computer readable medium has non-transitory program code recorded thereon which, when executed by the processor(s), causes the processor(s) to perform operations of receiving a signaling message from a wireless communication network. The signaling message includes a session interval and a device connection state indicator. The program code also causes the processor(s) to determine a device connection state based on the device connection state indicator. The program code further causes the processor(s) to transition to the device connection state for a time period corresponding to the session interval.

Another aspect of the present disclosure discloses a wireless communication apparatus having a memory and at least one processor coupled to the memory. The processor(s) is configured to receive a signaling message from a wireless communication network. The signaling message includes a session interval and a device connection state indicator. The processor(s) is also configured to determine a device connection state based on the device connection state indicator. The processor(s) is further configured to transition to the device connection state for a time period corresponding to the session interval.

In one aspect of the present disclosure, a method of wireless communication is disclosed. The method includes receiving a session termination command for a device. The session termination command includes a session indicator. The method also includes transmitting a signaling message including a device connection state indicating a succeeding communication state of the device. The device connection state is based on the session indicator.

Another aspect of the present disclosure is directed to an apparatus including means for receiving a session termination command for a device. The session termination command includes a session indicator. The apparatus also includes means for transmitting a signaling message including a device connection state indicating a succeeding communication state of the device. The device connection state is based on the session indicator.

In another aspect of the present disclosure, a computer program product for wireless communications in a wireless network having a non-transitory computer-readable medium is disclosed. The computer readable medium has non-transitory program code recorded thereon which, when executed by the processor(s), causes the processor(s) to perform operations of receiving a session termination command for a device. The session termination command includes a session indicator. The program code also causes the processor(s) to transmit a signaling message including a device connection state indicating a succeeding communication state of the device. The device connection state is based on the session indicator.

Another aspect of the present disclosure discloses wireless communication apparatus having a memory and at least one processor coupled to the memory. The processor(s) is configured receive a session termination command for a device. The session termination command includes a session indicator. The processor(s) is also configured to transmit a signaling message including a device connection state indicating a succeeding communication state of the device. The device connection state is based on the session indicator.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system according to an aspect of the present disclosure.

FIG. 2 illustrates an example of a wireless communication system implementing a machine type communication service according to an aspect of the present disclosure.

FIG. 3 illustrates an example of a wireless communication system implementing a machine type communication service according to an aspect of the present disclosure.

FIG. 4 is a device state diagram for network directed session control according to an aspect of the present disclosure.

FIG. 5 is a communication flow for network directed session control according to an aspect of the present disclosure.

FIG. 6 is a communication flow for network directed session control according to an aspect of the present disclosure.

FIG. 7A is a block diagram illustrating a device for network directed device session control according to an aspect of the present disclosure.

FIG. 7B is a block diagram illustrating one configuration of a machine type communication connection state module according to an aspect of the present disclosure.

FIG. 8 is a block diagram of a device for network directed device session control according to an aspect of the present disclosure.

FIG. 9 is a block diagram of a device configured for network directed device session control according to an aspect of the present disclosure.

FIG. 10 is a block diagram of a system including a base station and a device according to an aspect of the present disclosure.

FIG. 11A is a flow chart illustrating one example of a method for network directed device session control according to an aspect of the present disclosure.

FIG. 11B is a flow chart illustrating another example of a method for network directed device session control according to an aspect of the present disclosure.

FIG. 12 is a flow chart illustrating another example of a method for network directed device session control according to an aspect of the present disclosure.

FIGS. 13 and 14 are block diagrams illustrating examples of hardware implementations for an apparatus employing a processing system.

### DETAILED DESCRIPTION

Methods, systems, and devices are described for improving device standby time and improving the use of network resources in a wireless communication network via network directed device session control. In various aspects of the present disclosure, the wireless communication network transmits session control parameters to a device using session messaging. In one configuration, the wireless communication network may transmit a time interval until the next device session. Alternatively, or in addition to, the wireless communication network may transmit a network attachment indicator that indicates whether the MTC device should remain attached to the network during the interval to the next communication session. In one configuration, when the network attachment indicator indicates that the MTC device should detach from the network, the MTC device may enter a low power or sleep mode to conserve battery power. In the low power or sleep mode, the MTC device may shut off various components, such as the receiver. Aspects of the present disclosure are directed to MTC devices, still, the aspects of the present disclosure are not limited to MTC devices and may be applicable to any device that collects data and/or processes information with or without human intervention.

Aspects of the present disclosure are directed to core network entities that manage device messaging for network directed device session control. In one configuration, an MTC server connected to the network informs the network of a session interval time. Furthermore, in this configuration, the MTC server may also inform the network on whether MTC devices should remain online to be available for paging during the session interval or should go offline and conserve battery power during the session interval. An offline MTC device may disable the receiver during the paging intervals. The MTC server may adaptively control the behavior of MTC devices based on MTC device data and/or other factors.

Aspects of the present disclosure may be applied to various wireless communications systems such as cellular wireless systems, Peer-to-Peer wireless communications, wireless local access networks (WLANs), ad hoc networks, satellite communications systems, and other systems. The terms “system” and “network” are often used interchangeably. These wireless communications systems may employ a variety of radio technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Examples of CDMA systems include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of OFDMA and OFDM systems include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). “LTE” may refer to LTE and LTE-Advanced. The techniques described herein may be used for the systems and radio technologies mentioned above as well as other systems and radio technologies. Software is construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

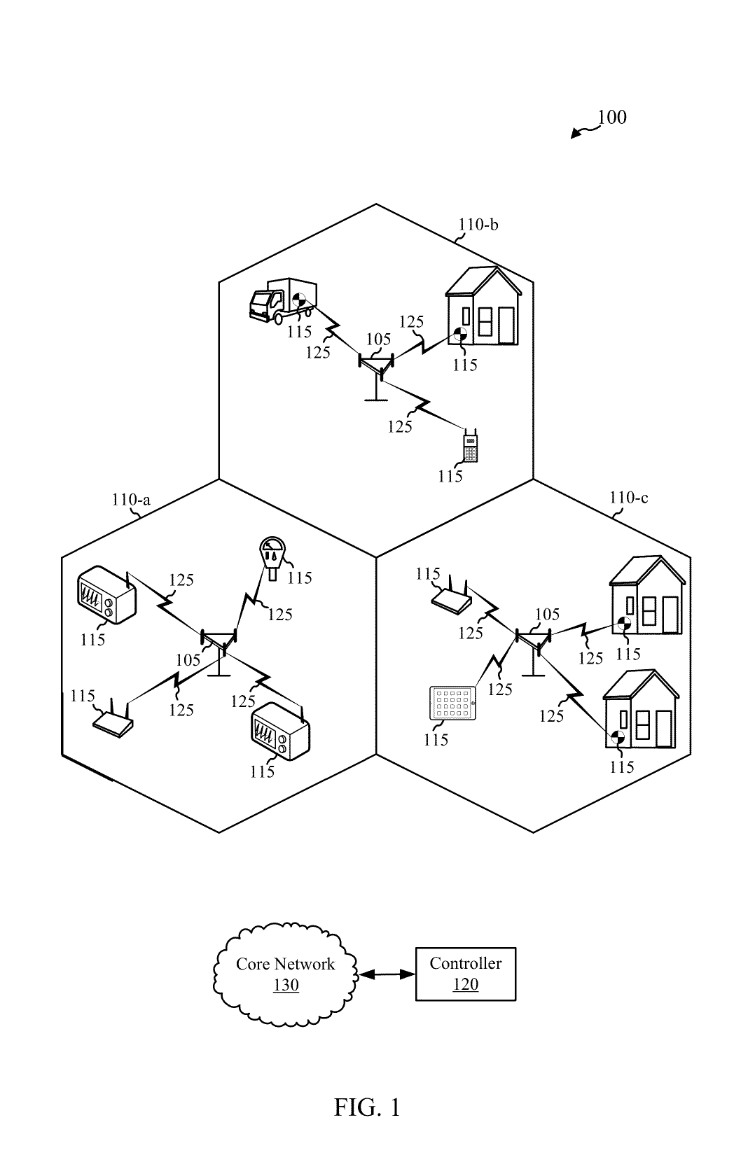

FIG. 1 illustrates an exemplary block diagram of a wireless communications system 100 according to an aspect of the present disclosure. The system 100 includes base stations 105, communication devices 115, a base station controller 120, and a core network 130. In one configuration the controller 120 is integrated into the core network 130. The base stations 105 may be referred to as cells. The system 100 may support operation on multiple carriers (e.g., waveform signals of different frequencies). Multi-carrier transmitters may transmit modulated signals simultaneously on the multiple carriers. For example, each modulated signal may be a multi-carrier channel modulated according to the various radio technologies described above. Each modulated signal may be transmitted on a different carrier and may include control information (e.g., pilot signals and/or control channels), overhead information, and/or data. The system 100 may be a multi-carrier LTE network capable of efficiently allocating network resources.

The base stations 105 may wirelessly communicate with the devices 115 via a base station antenna (not shown). The base stations 105 may communicate with the devices 115 under the control of the base station controller 120 via multiple carriers. Each base station 105 may provide communication coverage for a respective geographic area. The base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. In the wireless communications system 100 of FIG. 1, the coverage area for each base station 105 is identified as 110-a, 110-b, or 110-c. The coverage area for a base station may be divided into sectors (not shown). The wireless communications system 100 may include different types of base stations, such as macro, pico, and/or femto base stations. A macro base station may provide communication coverage for a relatively large geographic area (e.g., 35 km in radius). A pico base station may provide coverage for a relatively small geographic area (e.g., 12 km in radius), and a femto base station may provide communication coverage for a relatively smaller geographic area (e.g., 50 m in radius). In some cases, different technologies may overlap in coverage.

The devices 115 may be dispersed throughout the coverage areas 110. Each device 115 may be stationary or mobile. In one configuration, the devices 115 can communicate with different types of base stations such as, but not limited to, macro base stations, pico base stations, and femto base stations, via a communication link 125.

Some of the devices 115 may be machine type communication (MTC) devices that perform various functions, capture information, and/or communicate information with limited or no human intervention. For example, MTC devices may include sensors and/or meters for monitoring and/or tracking other devices, environmental conditions, etc. MTC devices may be standalone devices or, in some configurations, MTC devices may be incorporated in other devices. For example, devices (e.g., user equipment, mobile stations) such as smart phones, cellular phones and wireless communications devices, personal digital assistants (PDAs), tablets, other handheld devices, netbooks, ultrabooks, smartbooks, notebook computers, surveillance cameras, handled medical scanning devices, and/or home appliances may include one or more MTC device. In the ensuing description, various techniques are described as applied to communications and processing for a system including a network and one or more MTC device. It should be understood that the described techniques may be applied to other devices such as those incorporating MTC devices and/or other wireless communication devices.

The information collected by the MTC devices may be transmitted via a network to a back-end system, such as a server. The network may include components of system 100. For example, the transmission of data to/from the MTC devices may be routed through the base stations 105. The base stations 105 may communicate with the MTC devices on a forward link for transmitting signaling and/or information to the MTC devices and a reverse link for receiving signaling and/or information from the MTC devices.

In one example, the network controller 120 may be coupled to a set of base stations and provide coordination and control for these base stations 105. The controller 120 may communicate with the base stations 105 via a backhaul (e.g., core network 125). The base stations 105 may also directly communicate with each another or indirectly and/or via wireless or wireline backhaul.

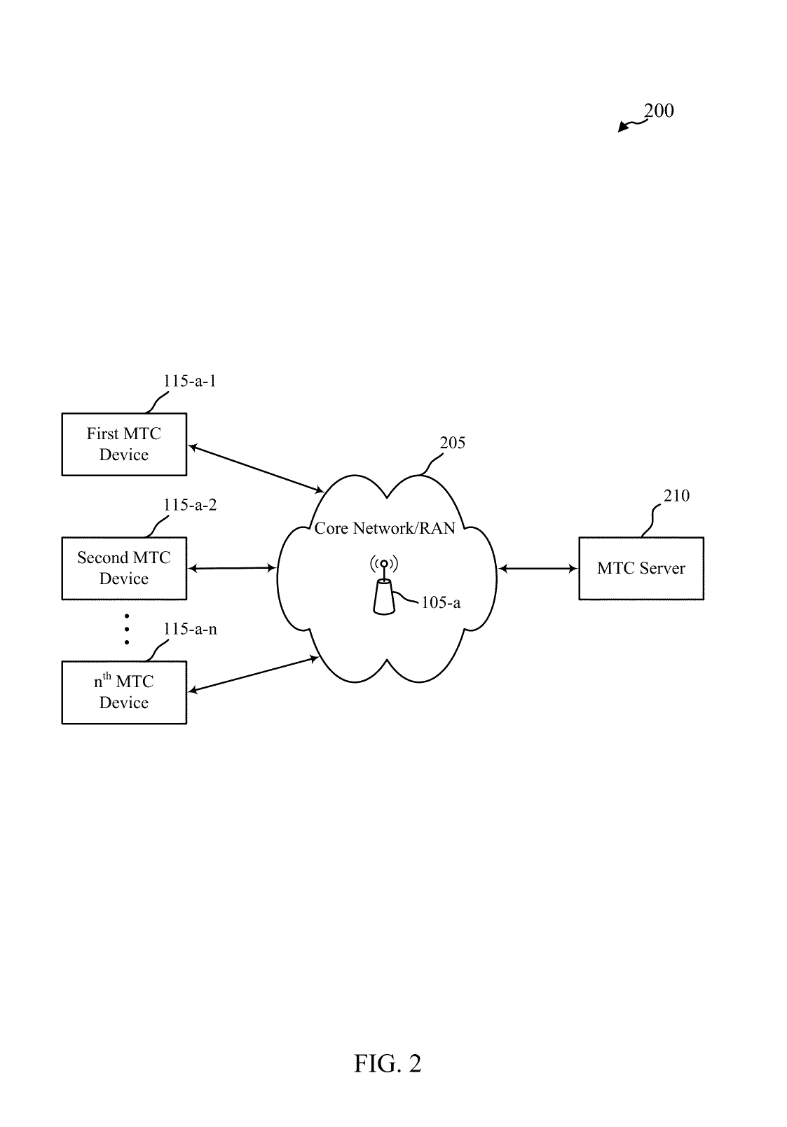

FIG. 2 illustrates an example of a wireless communication system 200 including a Radio Access Network (RAN) or Core Network (CN) 205 implementing a machine type communication service according to one aspect of the present disclosure. The system 200 may include one or more MTC devices, such as the first MTC device 115-a-1, second MTC device 115-a-2, and n^{th} MTC device 115-a-n. The system may also include an MTC server 210. Communications between the server 210 and MTC devices may be routed via a base station 105-a that may be considered part of the Core Network/RAN 205. The base station 105-a may be an example of the base stations illustrated in FIG. 1. The MTC devices 115-a-1, 115-a-2, 115-a-n may be examples of the MTC devices illustrated in FIG. 1. One skilled in the art would understand that the quantity of MTC devices 115-a-1, 115-a-2, 115-a-n, Core Networks/RANs 205, and MTC servers 210 shown in FIG. 2 is for illustration purposes only and should not be construed as limiting.

The wireless communication system 200 may be operable to facilitate machine type communication between one or more MTC devices 115-a-1, 115-a-2, 115-a-n and/or one or more base stations 105-a. Such communications may include communications between one or more devices without human intervention. In one example, machine type communication may include the automated exchange of data between a remote machine, such as a first MTC device 115-a-1, and a back-end IT infrastructure, such as the MTC server 210, without user intervention. The transfer of data from an MTC device 115-a-1, 115-a-2, 115-a-n to the MTC server 210 via the Core Network/RAN 205 (e.g., the base station 105-a) may be performed using reverse link communications. Data collected by the MTC devices 115-a-1, 115-a-2, 115-a-n (e.g., monitoring data, sensor data, meter data, etc.) may be transferred to the MTC server 210 on the reverse link communications.

The transfer of data from the MTC server 210 to an MTC device 115-a-1, 115-a-2, 115-a-n via the base station 105-a may be performed via forward link communications. The forward link may be used to transmit instructions, software updates, and/or messages to the MTC devices 115-a-1, 115-a-2, 115-a-n. The instructions may instruct the MTC devices 115-a-1, 115-a-2, 115-a-n to remotely monitor equipment, environmental conditions, etc. Machine type communication may be used with various applications such as, but not limited to, remote monitoring, measurement and condition recording, fleet management and asset tracking, in-field data collection, distribution, physical access control, and/or storage. The base station 105-a may generate one or more forward link frames with a small number of channels to transmit instructions, software updates, and/or messages. The various MTC devices 115-a-1, 115-a-2, 115-a-n may wake up to monitor a specific frame when instructions or other data is included on a channel of that frame.

In one embodiment, the behavior of the MTC devices may be pre-defined. For example, the day and/or time specified to monitor another device and transmit the collected information may be pre-defined for an MTC device. For example, the MTC device may be programmed to begin monitoring another device and collect information about that other device at a first pre-defined time period. The MTC device may also be programmed to transmit the collected information at a second pre-defined time period. The behavior of an MTC device may be remotely programmed.

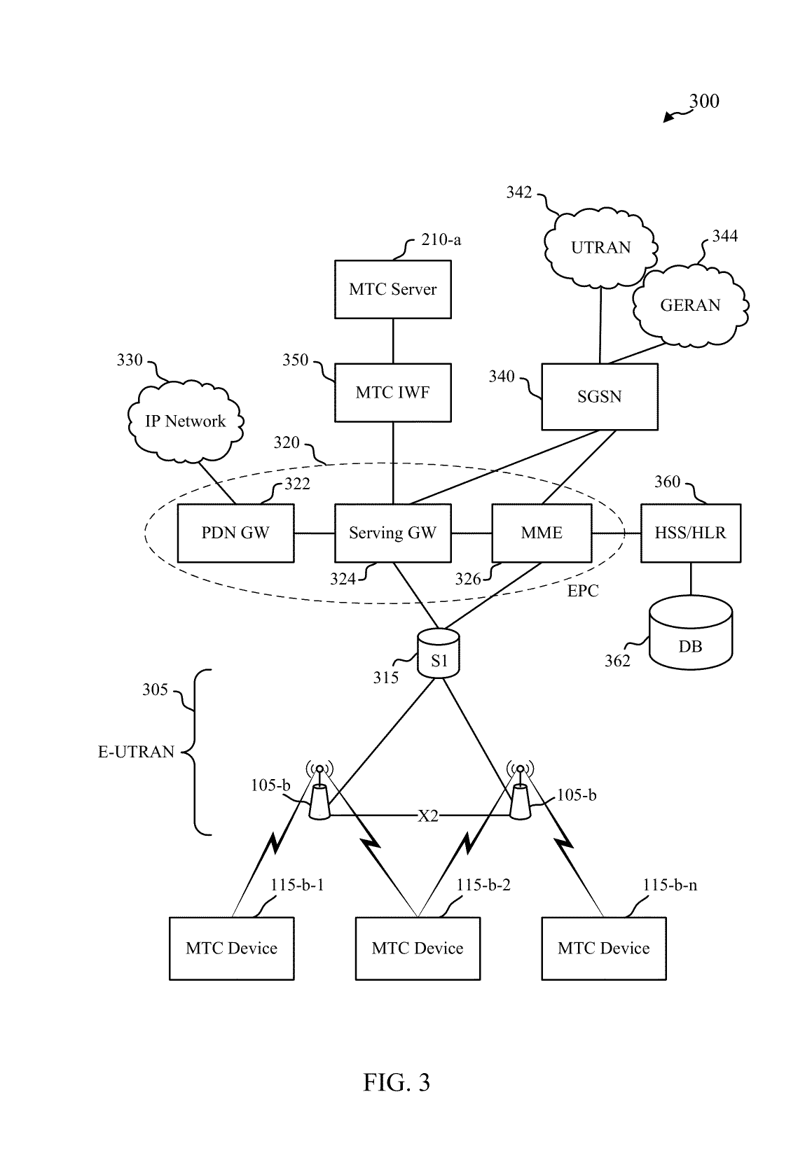

FIG. 3 illustrates an example of a wireless communications system 300 implementing a machine type communication service via an LTE/LTE-Advanced network in accordance with aspects of the present disclosure. The LTE/LTE-A network may include Evolved Universal Terrestrial Radio Access Network (E-UTRAN) 305 and Evolved Packet Core (EPC) 320. The LTE E-UTRAN 305 and EPC 320 may be configured to support end-to-end packet-switched communications. EPC 320 may include a Packet Data Network (PDN) Gateway 322. The PDN Gateway 322 may provide UE IP address allocation as well as other functions. The PDN Gateway 322 may be connected to one or more IP Networks 330. IP Networks 330 may include Operator IP Networks as well as external IP Networks. For example, IP Networks 330 may include the Internet, one or more Intranets, an IP Multimedia Subsystem (IMS), and a Packet-Switched (PS) Streaming Service (PSS). The EPC 320 may interconnect with other access networks using other Radio Access Technologies (RATs). For example, EPC 320 may interconnect with UTRAN 342 and/or GERAN 344 via one or more Serving GPRS Support Nodes (SGSNs) 340.

The EPC 320 may include one or more Serving Gateways 324 and/or Mobility Management Entities (MME) 326. The Serving Gateway 324 may handle the interface to E-UTRAN 305 and provide a communication point for inter-RAT mobility (e.g., handover to UTRAN 342 and/or GERAN 344, etc.). Generally, the MME 326 may provide bearer and connection management while the Serving Gateway 324 may transfer user IP packets between eNodeBs 105-b and other network end-points (e.g., PDN GW 322). For example, MME 326 may manage intra-RAT mobility functions (e.g., Serving Gateway selection) and/or UE tracking management. The Serving Gateway 324 and the MME 326 may be implemented in one physical node of EPC 320 or in separate physical nodes. A Home Subscriber Service (HSS) and/or home location register (HLR) node 360 may provide service authorization and/or user authentication for UEs. HSS/HLR node 360 may communicate with one or more databases 362.

The E-UTRAN 305 may include one or more base stations or eNodeBs 105-b, which provide user and control plane protocol terminations for UEs (e.g., MTC devices 115-b) over the air interface of the LTE network. eNodeBs 105-b may be connected with an X2 interface for intra-eNodeB communication. eNodeBs 105-b may be connected to Serving Gateway 324 and/or MME 326 over an S-1 interface 315 for communicating data traffic and/or control plane information. The MTC devices 115-b may be configured to collaboratively communicate with multiple eNodeBs 105-b through, for example, Multiple Input Multiple Output (MIMO), Coordinated Multi-Point (CoMP), or other schemes as described in more detail below.

In one aspect of the present disclosure, the wireless communication network 300 includes an MTC inter-working function (IWF) module 350. The MTC IWF module 350 may provide an interface between the EPC 320 and one or more external MTC Servers 210-a for providing MTC service within the LTE network. An MTC server 210-a may be operated by the proprietor of MTC devices and may perform functions associated with deployment of MTC devices such as receiving and processing MTC device data. The MTC server 210-a may be connected directly to the EPC 320 or may be connected via the MTC IWF module 350 and/or other networks such as the Internet. MTC IWF module 350 may be implemented in one or more existing physical nodes of the EPC 320 (e.g., Serving Gateway 324, etc.), or in a separate physical node connected to EPC 320.

The various aspects of the present disclosure are presented to improve MTC device standby time and improve the use of network resources in a wireless communication network via network directed device session control. In one configuration, the wireless communication network communicates various session control parameters to an MTC device using session messaging.

Specifically, the wireless communication network may transmit a time interval until the next device session to the MTC device. Alternatively, or in addition to, the wireless communication network may transmit a network attachment indicator (e.g., device connection state indicator) that indicates whether the MTC device should remain attached to the network during the interval to the next communication session. In one configuration, when the network attachment indicator indicates that the MTC device should detach from the network, the MTC device may enter a low power or sleep mode to conserve battery power.

Aspects of the present disclosure are directed to core network entities that manage device messaging for network directed device session control. In one configuration, an MTC server informs the network of a session interval time. Furthermore, in this configuration, the MTC server may also inform the network on whether MTC devices should remain online to be available for paging during the session interval or should go offline and conserve battery power during the session interval. An offline MTC device may disable the receiver during the paging intervals. The MTC server may adaptively control the behavior of MTC devices based on MTC device data and/or other factors.

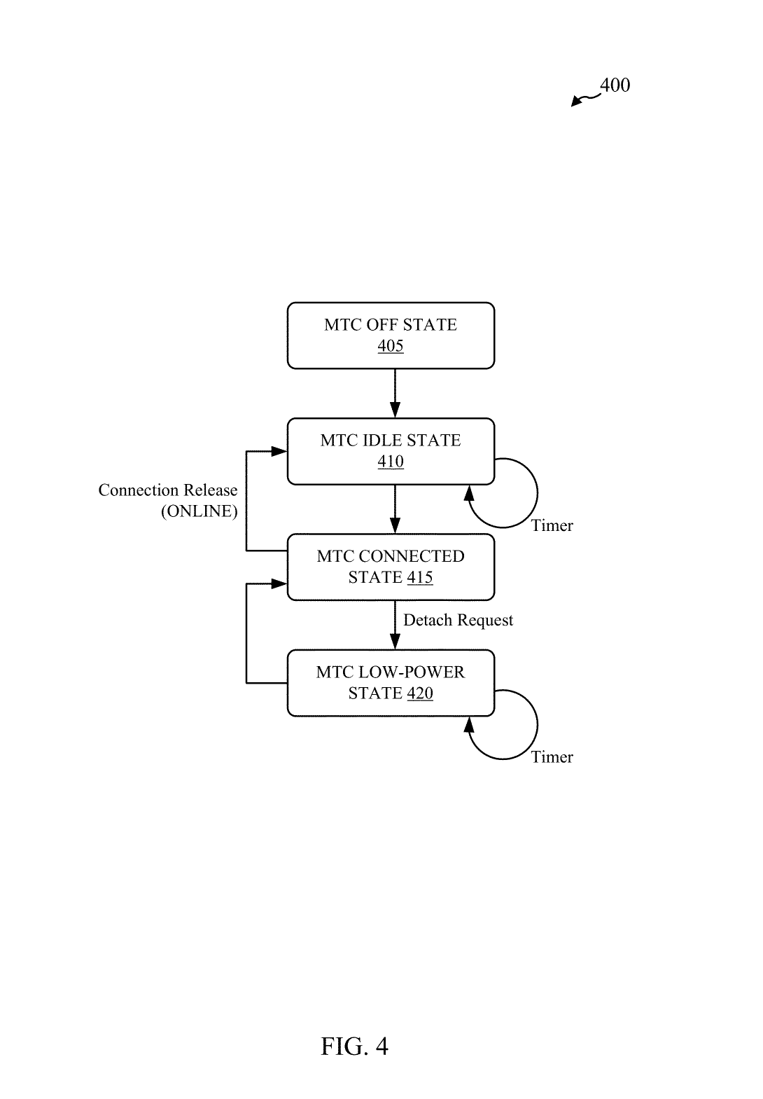

FIG. 4 illustrates an exemplary device state diagram 400 for network directed session control according to an aspect of the present disclosure. Specifically, as shown in FIG. 4, the device state diagram 400 illustrates communication states for a device such as an MTC device. The communication states may include an MTC Off State 405, an MTC Idle State 410, an MTC Connected State 415, and an MTC Low-Power State 420.

In the device state diagram 400, MTC Off State 405 may correspond to a powered-off state in which the MTC device is turned off and is not communicating with a network. The MTC device may transition from the MTC Off State 405 to the MTC Idle State 410 after the MTC device has been powered on. In the MTC Idle State 410, the MTC device may communicate with a network, such as the core network/RAN, to register or camp on the network. The MTC device may remain in the MTC Idle State 410 until a timer expires. Registration of the MTC device on the network may also be referred to as a network attachment. Registration and/or attachment may include transmitting an attach request from the MTC device to the network and receiving a valid device identification for the network. The MTC device identification may include a Temporary Mobile Subscriber Identity (TMSI) and/or a Mobile Equipment Identifier (MEI). Registration and/or attachment may also include authentication on the network and bearer context setup in the MTC device and network. In the MTC Idle State 410, the MTC device may monitor downlink system information and paging information. Furthermore, in the MTC Idle State 410 the MTC device may make measurements of a serving call or neighbor cell for cell reselection. In E-UTRAN networks, the MTC Idle State 410 may correspond to the RRC_IDLE service state.

In one configuration, the MTC Connected State 415 is used for data sessions between the MTC device and other networks via the core network/RAN. In the MTC Connected State 415, the MTC device may establish a radio resource control (RRC) connection with the core network. In E-UTRAN networks, the MTC Connected State 415 may correspond to the RRC_CONNECTED service state.

In the present configuration, the MTC device transitions to the MTC Low-Power State 420 from the MTC Connected State 415 based on signaling messages received from the network. For example, the network may transmit a detach request with a timer value associated with a wait period for re-attaching to the network. The MTC device may detach from the network and remain in the MTC Low-Power State 420 until the timer expires. In one configuration, the MTC device may return to the MTC Connected State 415 and/or the MTC Idle State 410 (e.g., via Connection Release message). In another configuration, the network detach is local and the MTC device does not signal the detach to the network. In the MTC Low-Power State 420, the MTC device may shut down the MTC device receiver or portions of the MTC device receiver such that the MTC device does not monitor paging channels and/or channel conditions.

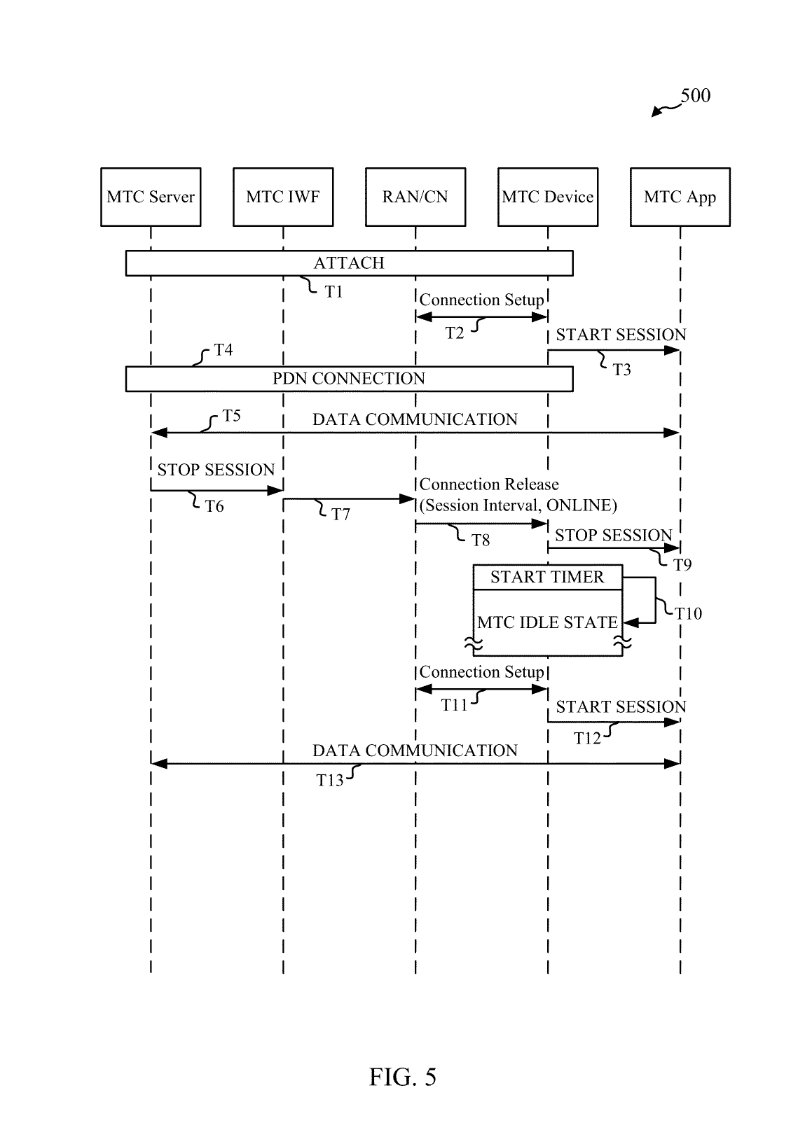

FIG. 5 is a flow diagram 500 illustrating network directed session control according to an aspect of the present disclosure. In the communication flow 500, the MTC server may control session behavior of an MTC device to improve network resource usage and improve the MTC device's standby time.

Initially, in the communication flow 500, the MTC device may be attached to the core network at time T1. Once attached, the MTC device may establish a connection to the core network (CN) at time T2. At time T3, a session for an MTC application may be initiated by the MTC device. Moreover, after the session has been initiated, at time T4 the MTC application may connect to the MTC server via packet data network (PDN) connection. While the MTC application is connected to the MTC server, at time T5, the MTC application may perform data communications such as measuring data, collecting data, and/or transmitting data to the MTC server.

Subsequently, the MTC server may determine that the communication session is complete. The MTC server may also determine when the MTC device should initiate the next communication session. Additionally, the MTC server may also determine whether the MTC device should remain online or in a low power state until the next communication session. The low power state may be the aforementioned MTC Low-Power State. That is, the MTC device may not receive page requests while in the low power state.

In one configuration, the MTC server determines a communication session interval for the MTC device and that the MTC device should remain online during the communication session interval. The MTC device may be considered reachable when it is in an online state. At time T6, the MTC server may transmit a stop session message to the MTC interworking function (IWF) including the communication session interval and/or a network attachment indicator that indicates whether the MTC device should remain reachable via paging during the communication session interval.

At time T7, the MTC IWF may forward the stop session message to the core network. Furthermore, at time T8, the core network may transmit a signaling message to the MTC device. The signaling message may include parameters corresponding to the communication session interval and/or the network attachment indicator. If the session interval is not included in the stop session message transmitted from the MTC server, the core network may set the session interval in the connection release message to a time period corresponding to the periodic registration procedure for the core network. In one configuration, the connection release message is an RRC connection release message and the session interval may be included in the extendedWaitTime field of the RRC Connection Release message. In another configuration, the RRC Connection Release message includes the network attachment parameter.

Upon receipt of the connection release message, the MTC device may stop the MTC application session at time T9. Furthermore, at time T10, the MTC device may start a timer defined by the received session interval time and transition to a communication state, such as the MTC Idle State where the MTC device remains available for paging messages from the core network. During the session interval defined by the timer, various components of the MTC device may be disabled or powered down. However, the MTC device may continue to monitor downlink communications, such as monitoring paging messaging and/or measuring channel conditions, of the core network.

Upon expiration of the timer (e.g., end of the MTC Idle State), the MTC device may re-establish a connection to the core network at time T11. For example, the MTC device may transition to the MTC connected state described above and/or re-establish an RRC connection to the core network. The MTC device may restart the session of MTC application at time T12. Finally, at time T13, the MTC application may resume data communications with the MTC server via the core network.

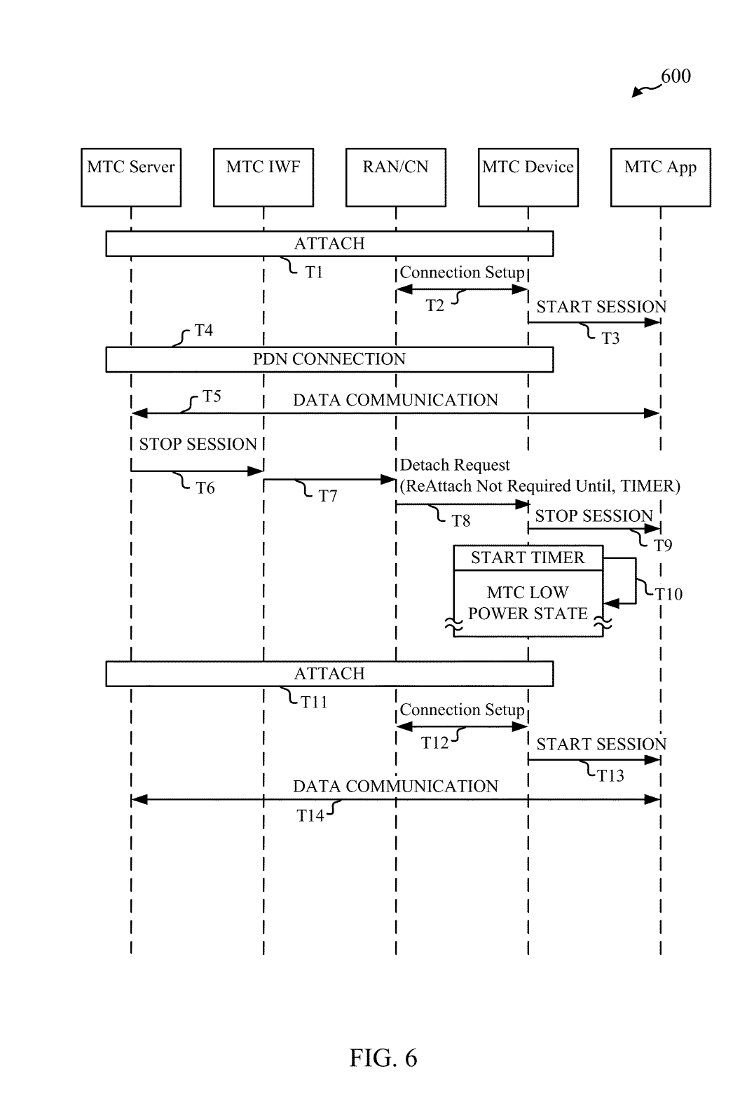

FIG. 6 illustrates a flow diagram 600 for network directed device session control according to an aspect of the present disclosure. The MTC server may control session behavior of an MTC device to improve network resource usage and improve the MTC device's standby time.

Initially, in the communication flow 600, the MTC device may be attached to the core network at time T1. Once attached, the MTC device may establish a connection to the core network at time T2. At time T3, a session for an MTC application may be initiated by the MTC device. Moreover, after the session has been initiated, at time T4 the MTC application may connect to the MTC server via a packet data network (PDN) connection. While the MTC application is connected to the MTC server, at time T5, the MTC application may perform data communications such as measuring data, collecting data, and/or transmitting data to the MTC server.

Subsequently, the MTC server may determine that the communication session is complete. The MTC server may also determine when the MTC device should initiate the next communication session. Additionally, the MTC server may also determine whether the MTC device should remain online or in a low power state until the next communication session. In this configuration, the MTC server determines that the MTC device does not need to be reachable for paging during the communication session interval. Therefore, in the present configuration, the MTC server may transmit a stop session message to the MTC IWF at time T6. The stop session message may include the communication session interval and a network attachment indicator that indicates that the MTC device does not need to be reachable via paging during the communication session interval.

Furthermore, at time T7, the MTC IWF may forward the stop session message to the core network. The core network may transmit, at time T8, a signaling message informing the MTC device that it can detach from the network for the time period corresponding to the communication session interval. For example, at time T8, the core network may initiate a detach procedure for the MTC device. The detach procedure may indicate to the MTC device that re-attaching is not required for a time period corresponding to the communication session interval. In one configuration, the core network transmits the detach request at time T8 with a detach type parameter and timer value. The detach type parameter may be set to indicate that no re-attachment is expected until a time period corresponding to the timer value has expired. If the session interval is not included in the stop session message transmitted from the MTC server at time T6, the core network may set the timer value to a default value. For example, the timer value may be set to a time period corresponding to the periodic registration procedure for the core network. In another configuration, the signaling message transmitted from core network, at time T8, is an RRC Connection Release message that includes the session interval and network attachment indicator.

Additionally, at time T9, in response to receiving the signaling message transmitted at time T8, the MTC device may stop the MTC application session. At time T10, the MTC device may initiate a timer defined by the received session interval or re-attachment time and enter a communication state, such as a low-power state. In the low-power state, the MTC device may not receive paging messages from the core network. In one configuration, the lower power state is the aforementioned MTC Low Power State.

Upon expiration of the timer (e.g., end of the MTC Idle State), the MTC device may re-attach to the core network at time T11. Furthermore, at time T12, the MTC device may re-establish a connection to the core network. The MTC device may restart the session of the MTC application at time T13. Finally, at time T14, the MTC application may resume data communications with the MTC server via the core network.

Aspects of the present disclosure may be used to perform adaptive session control by the MTC server. For example, various MTC devices may be configured to perform measurements or other functions during each MTC device session. For these MTC devices, the MTC server may control the time periods between the measurements or other functions based on the session interval. The MTC server may adaptively change the session interval periods based on the measured data or other factors. That is, the MTC server may control the behavior of MTC devices, such as measurement intervals, based on an environment or other conditions.

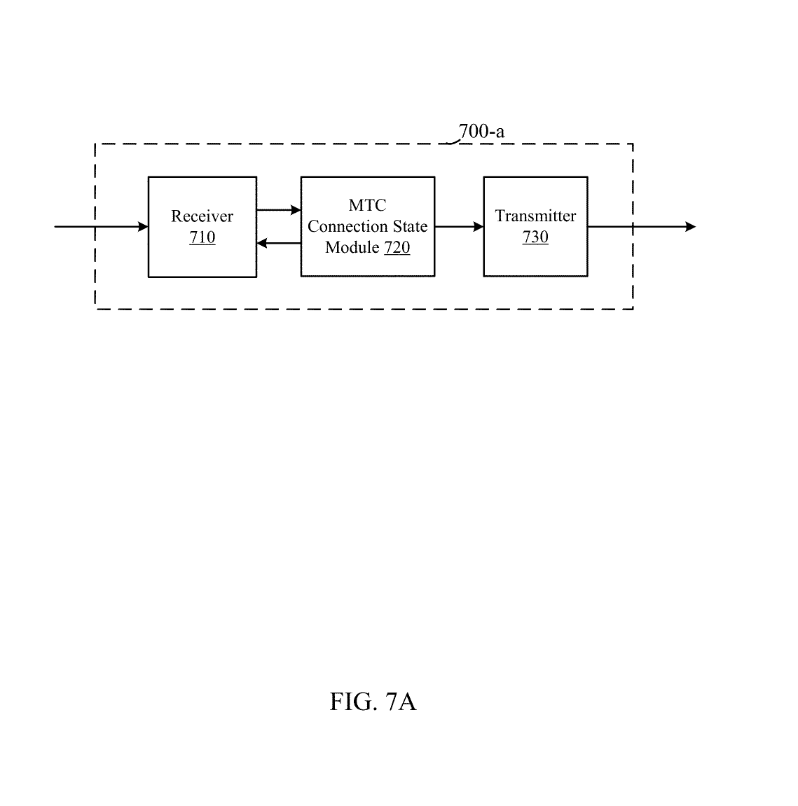

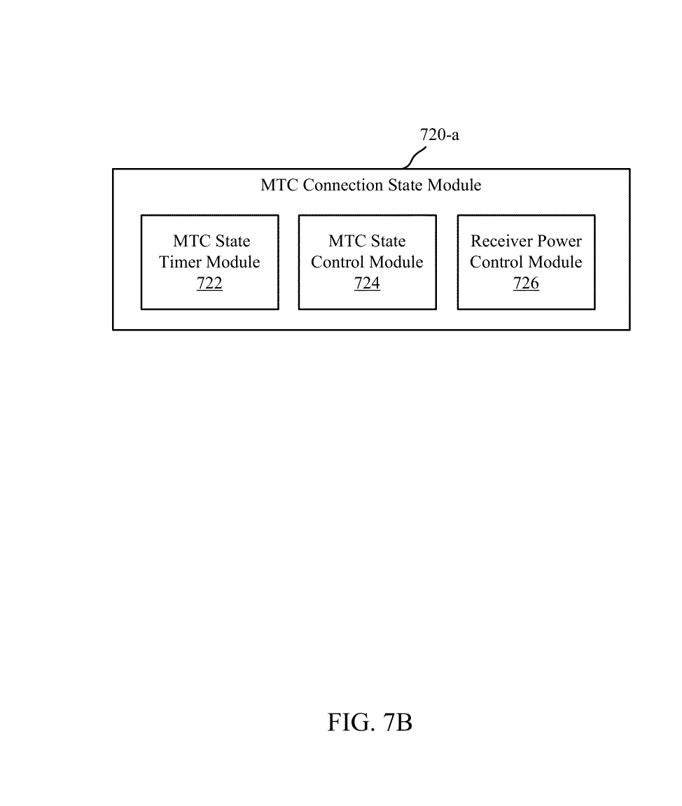

FIG. 7A illustrates a block diagram of an MTC device 700-a for network directed device session control according to an aspect of the present disclosure. The MTC device 700-a may be an example of one or more configurations of MTC devices described with reference to FIGS. 1, 2, and 3. The MTC device 700-a may also be a processor. The MTC device 700-a may include a receiver module 710, an MTC connection state module 720, and/or a transmitter module 730. Each of these components may communicate with each other.

The receiver module 710, the MTC connection state module 720, and/or the transmitter module 730 of the MTC device 700-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the MTC device 700-a.

The receiver module 710 may receive information such as packet information, data information, and/or signaling information. The receiver module 710 may be configured to receive downlink or forward link control channels and data channels from base stations 105. The receiver module 710 may also be configured to receive instructions, a set of operations, messages, etc. from base stations 105. The received information may be used by the MTC connection state module 720 for a variety of purposes.

The MTC connection state module 720 may be configured to receive and process network directed device session control messages. For example, the MTC connection state module 720 may receive succeeding communication state information (e.g., Detach Requests, Connection Release messages, etc.) and control communication state transitioning for the MTC device based on the communication state information provided by the network. The MTC connection state module 720 may be configured to control features related to power consumption of the transmitter module 730 and receiver 710. For example, the MTC connection state module 720 may be configured to power down or disable various portions of the receiver 710 based on the communication state.

The transmitter module 730 may transmit information such as packet information, data information, and/or signaling information. The transmitter module 730 may be configured to transmit uplink or reverse link control and data channels to base stations 105. The transmitter module 730 may also be configured to transmit instructions, a set of operations, messages, etc. to base stations 105. The transmitted information may be related to operations of the MTC connection state module 720.

FIG. 7B is a block diagram illustrating the MTC connection state module 720-a based on an aspect of the present disclosure. The MTC connection state module 720-a may be an example of the MTC connection state module 720 of FIG. 7A. In one configuration, the MTC connection state module 720-a may include an MTC state timer module 722, MTC state control module 724, and/or receiver power control module 726. Each of these components may communicate with each other.

The MTC state timer module 722, the MTC state control module 724, and/or the receiver power control module 726 of the MTC connection state module 720-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the MTC connection state module 720-a.

The MTC state timer module 722 may be configured to receive and process a session interval time, including counting down the delay time for session intervals. The MTC state control module 724 may be configured to control communication state transitions of the MTC device based on control signal messaging from the network and timer delay information from MTC state timer module 722. The receiver power control module 726 may be configured to control receiver power consumption including shutting down portions of the receiver (e.g., the receiver 710, etc.), during the MTC Low-Power State 420 to improve device standby time.

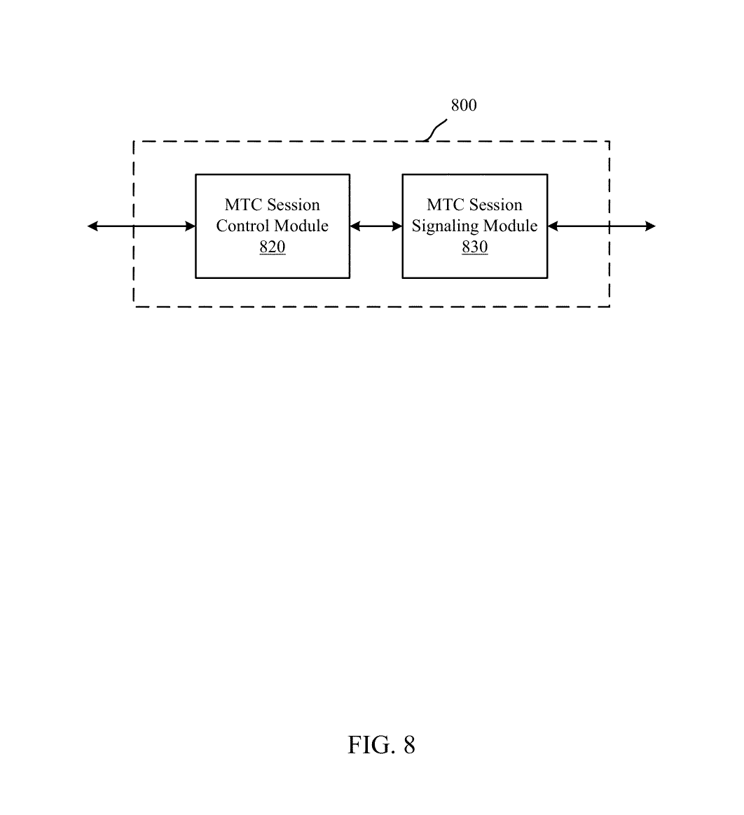

FIG. 8 is a block diagram that illustrates a device 800 for network directed device session control in accordance with various aspects. The device 800 may be an example of one or more aspects of network entities described with reference to FIGS. 1, 2, and 3. For example, the device may be an example of aspects of the MTC IWF module 350 and/or core network 205. The device 800 may also be a processor. The device 800 may include an MTC session control module 820 and/or an MTC session signaling module 830. Each of these components may communicate with each other.

The MTC session control module 820 and/or an session signaling module 830 of the device 800 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the device 800.

The MTC session control module 820 may be configured to receive session termination commands related to devices. For example, the MTC session control module 820 may receive session termination commands from an MTC server 210. The session termination commands may include a session termination availability indicator.

MTC session signaling module 830 may be configured to send signaling messages to devices such as MTC devices. The MTC session signaling module 830 may be configured to send a network attachment indicator in signaling messages indicating a succeeding communication state of the device. The MTC session signaling module 830 may be configured to send a network wait time parameter corresponding to a session interval wait time in signaling messages. The MTC session signaling module 830 may be configured to determine whether the device should be enabled to receive mobile terminated communications and send appropriate detach requests and/or connection release messages based on the determination.

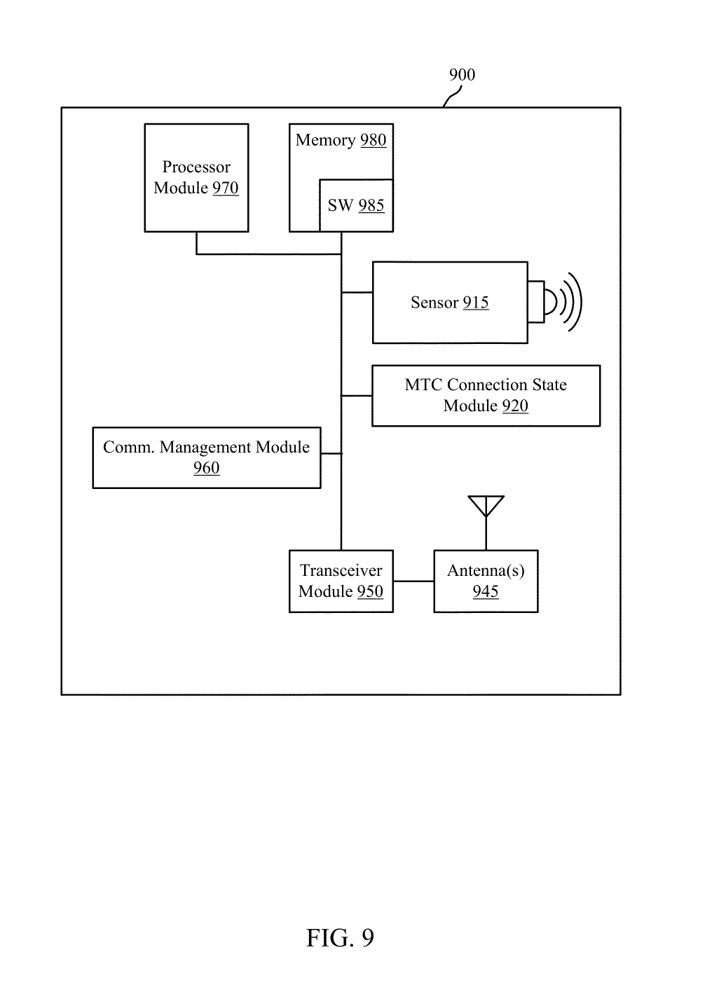

FIG. 9 is a block diagram of an MTC device 900 configured for network directed device session control in accordance with aspects of the present disclosure. The MTC device 900 may include an internal power supply (not shown), such as a small battery, to facilitate mobile operation. In one configuration, the MTC device 900 may be an MTC device or a component of an MTC device illustrated in FIGS. 1, 2 and/or 3. The MTC device 900 may include aspects of MTC devices 700-a and/or 720-a of FIG. 7A and/or FIG. 7B. The MTC device 900 may be a multi-mode wireless device. The MTC device 900 may also be referred to as an MTC UE or M2M device.

The MTC device 900 may include one or more sensors 915, antenna(s) 945, a transceiver module 950, a communication management module 960, a processor module 970, a memory 980, and an MTC connection state module 920. Each of the aforementioned modules may communicate, directly or indirectly, with each other (e.g., via one or more buses). The transceiver module 950 may be configured to communicate bi-directionally, via the antenna(s) 945 and/or one or more wired or wireless links, with one or more networks, as described above. For example, the transceiver module 950 may be configured to communicate bi-directionally with base stations 105 of FIGS. 1, 2, and/or 3. The transceiver module 950 may include a modem configured to modulate the packets and provide the modulated packets to the antenna(s) 945 for transmission, and to demodulate packets received from the antenna(s) 945. While the MTC device 900 may include a single antenna 945, the MTC device 900 may include multiple antennas 945 for multiple transmission links.

The memory 980 may include random access memory (RAM) and read-only memory (ROM). The memory 980 may store computer-readable, computer-executable software code 985 containing instructions configured, when executed, to cause the processor module 970 to perform various functions described herein (e.g., data capture, database management, message routing, etc.). Alternatively, the software code 985 may not be directly executable by the processor module 970 but be configured to cause a computer (e.g., when compiled and executed) to perform functions described herein. The processor module 970 may include an intelligent hardware device, e.g., a central processing unit (CPU) such as those made by Intel® Corporation or AMD®, a microcontroller, an application-specific integrated circuit (ASIC), etc.

According to the architecture of FIG. 9, the MTC device 900 may include a communications management module 960. The communications management module 960 may manage communications with base stations 105 and/or other MTC devices. By way of example, the communications management module 960 may be a component of the MTC device 900 in communication with some or all of the other components of the MTC device 900 via a bus. Alternatively, functionality of the communications management module 960 may be implemented as a component of the transceiver module 950, as a computer program product, and/or as one or more controller elements of the processor module 970.

The components for MTC device 900 may be configured to implement aspects discussed above with respect to MTC devices 700-a and/or 720-a of FIG. 7A and/or FIG. 7B and may not be repeated here for the sake of brevity. For example, the MTC connection state module 920 may include similar functionality as the MTC connection state module 720 of FIG. 7A and/or FIG. 7B.

In one configuration, the transceiver module 950 in conjunction with antenna(s) 945, along with other possible components of the MTC device 900, may transmit information for network directed device session control from the MTC device 900 to base stations or a core network. In another configuration, the transceiver module 950, in conjunction with antennas 945 along with other possible components of MTC device 900, may transmit information, such as signaling messaging and/or session data to base stations or a core network.

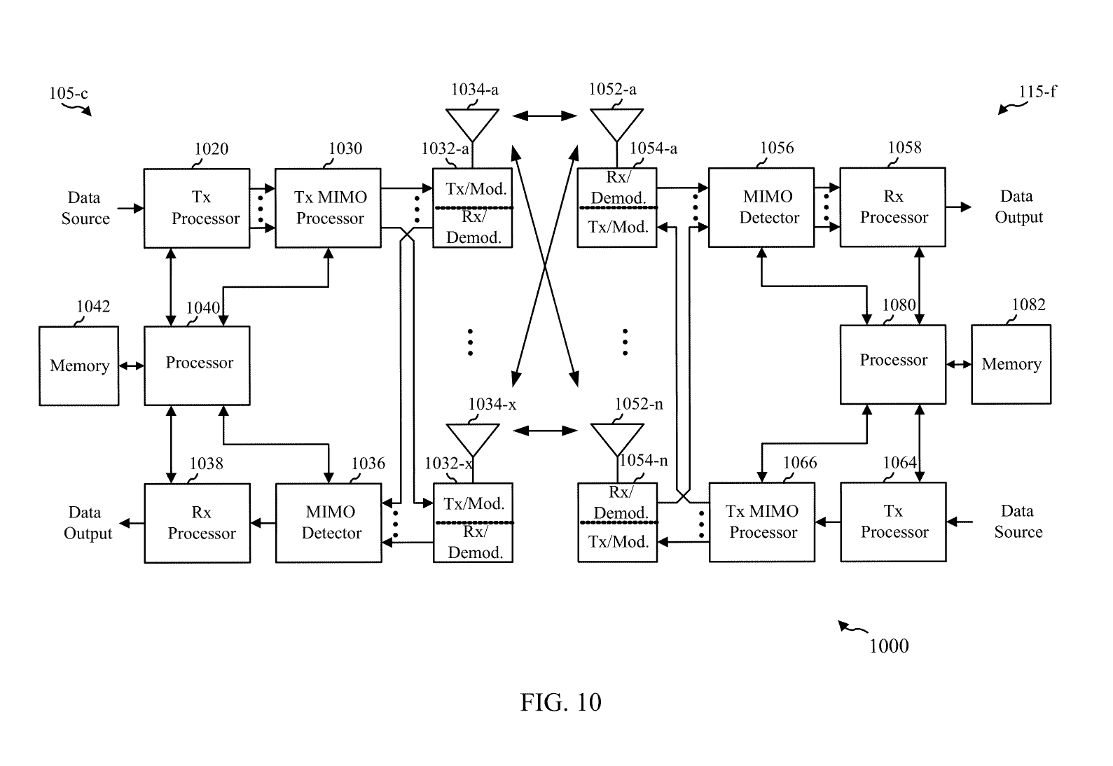

FIG. 10 is a block diagram of a system 1000 including a base station 105-c and a MTC device 115-f in accordance with various embodiments. This system 1000 may be an example of aspects of the systems described in of FIGS. 1, 2, and/or 3. The base station 105-c may be equipped with antennas 1034-a through 1034-x, and the MTC device 115-f may be equipped with antennas 1052-a through 1052-n. At the base station 105-c, a transmitter processor 1020 may receive data from a data source.

The transmitter processor 1020 may process the data. The transmitter processor 1020 may also generate reference symbols, and a cell-specific reference signal. A transmit (TX) MIMO processor 1030 may perform spatial processing (e.g., precoding) on data symbols, control symbols, and/or reference symbols, if applicable, and may provide output symbol streams to the transmit modulators 1032-a through 1032-x. Each modulator 1032 may process a respective output symbol stream (e.g., for OFDM, etc.) to obtain an output sample stream. Each modulator 1032 may further process (e.g., convert to analog, amplify, filter, and upconvert) the output sample stream to obtain a downlink (DL) signal. In one example, DL signals from modulators 1032-a through 1032-x may be transmitted via the antennas 1034-a through 1034-x, respectively. The transmitter processor 1020 may receive information from a processor 1040. The processor 1040 may be configured to perform network communications in accordance with the network directed device session control embodiments described above. In some embodiments, the processor 1040 may be implemented as part of a general processor, the transmitter processor 1020, and/or the receiver processor 1038. A memory 1042 may be coupled with the processor 1040.

In some embodiments, the processor 1040 is configured to transmit and receive signaling messages for network directed device session control. For example, processor 1040 may be configured to transmit signaling messages for network directed device session control in conjunction with transmitter processor 1020 and transmitter MIMO processor 1030, modulators/demodulators 1032 and antennas 1034. Processor 1040 may further be configured to receive signaling messages for network directed device session control through MIMO detector 1036 and receiver processor 1038, demodulators 1032, and antennas 1034.

At the MTC device 115-f, the antennas 1052-a through 1052-n may receive the DL signals from the base station 105-c and may provide the received signals to the demodulators 1054-a through 1054-n, respectively. Each demodulator 1054 may condition (e.g., filter, amplify, downconvert, and digitize) a respective received signal to obtain input samples. Each demodulator 1054 may further process the input samples (e.g., for OFDM, etc.) to obtain received symbols. A MIMO detector 1056 may obtain received symbols from all the demodulators 1054-a through 1054-n, perform MIMO detection on the received symbols if applicable, and provide detected symbols. A receiver processor 1058 may process (e.g., demodulate, deinterleave, and decode) the detected symbols, providing decoded data to a data output, and provide decoded control information to a processor 1080, or memory 1082.

On the uplink (UL), at the MTC device 115-f, a transmitter processor 1064 may receive and process data from a data source. The transmitter processor 1064 may also generate reference symbols for a reference signal. The symbols from the transmitter processor 1064 may be precoded by a transmit MIMO processor 1066 if applicable, further processed by the modulators 1054-a through 1054-n (e.g., for SC-FDMA, etc.), and be transmitted to the base station 105-c in accordance with the transmission parameters received from the base station 105-c. The transmitter processor 1064 may be configured to transmit signaling in accordance with the network directed device session control embodiments described above. At the base station 105-c, the UL signals from the MTC device 115-f may be received by the antennas 1034, processed by the demodulators 1032, detected by a MIMO detector 1036 if applicable, and further processed by a receive processor. The receiver processor 1038 may provide decoded data to a data output and to the processor 1040. In some embodiments, the processor 1080 may be implemented as part of a general processor, the transmitter processor 1064, and/or the receiver processor 1058.

In one configuration, the processor 1080 is configured to receive and process network directed device session control messages. For example, the processor 1080 may receive succeeding communication state information (e.g., Detach Requests, Connection Release messages, etc.) and control communication state transitioning for the device based on the communication state information provided by the network. The processor 1080 may be configured to control features related to power consumption of the transmission and reception components (e.g., modulators/demodulators 1054, MIMO detector 1056, receiver processor 1058, transmit MIMO processor 1066, and/or transmitter processor 1064, etc.) For example, the processor 1080 may be configured to power down or disable various portions of these components based on the communication state as described above.

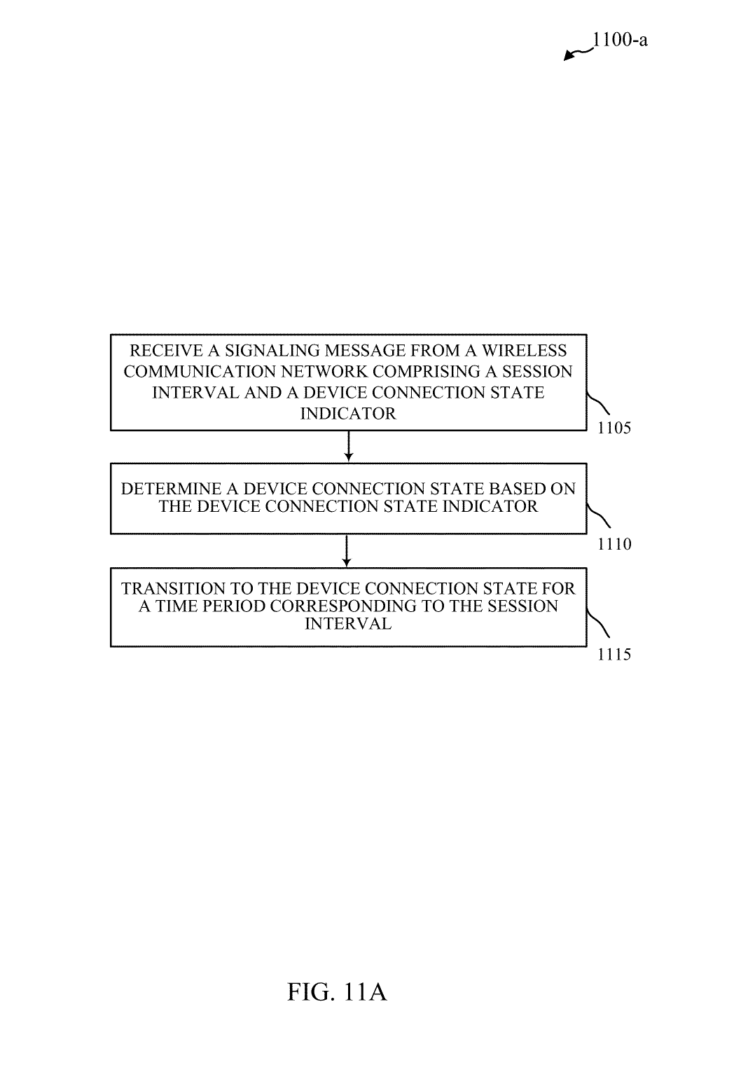

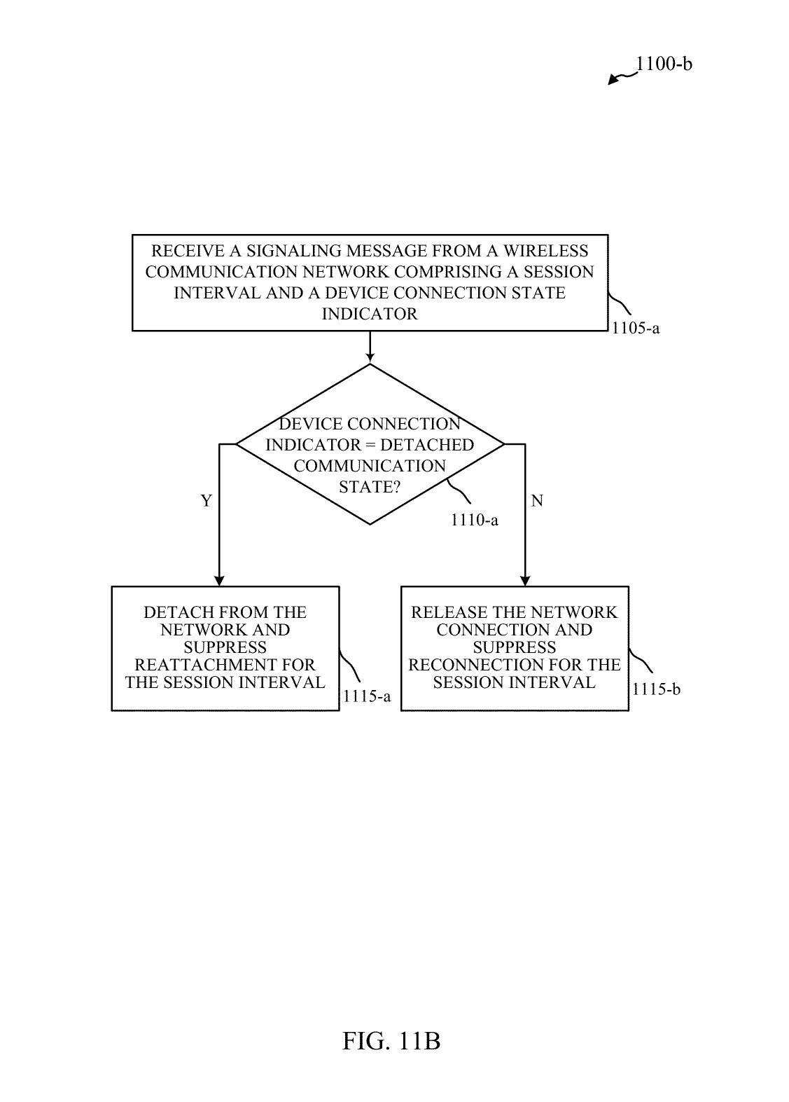

FIG. 11A shows a flow chart illustrating a method 1100-a for network directed device session control according to an aspect of the present disclosure. At block 1105, an MTC device receives a signaling message from a wireless communication network comprising a session interval and a device connection state indicator. At block 1110, the MTC device determines a device connection state based on the device connection state indicator. Furthermore, at block 1115, the MTC device transitions to the device connection state for a time period corresponding to the session interval.

FIG. 11B is a flow chart illustrating a method 1100-b for network directed device session control according to an aspect of the present disclosure. At block 1105-a, an MTC device receives a signaling message from a wireless communication network comprising a session interval and a device connection state indicator. At block 1110-a, the MTC device determines whether the device connection state indicator indicates a detached communication state.

In one configuration, when the MTC device determines, at block 1110-a, that the device connection state indicator indicates a detached communication state, the MTC device may proceed to block 1115-a to detach from the wireless communication network and suppress re-attachment for the time period corresponding to the session interval. Alternatively, when the MTC device determines, at block 1110-a, that the device connection state indicator of the signaling message indicates a communication standby state, the MTC device may proceed to block 1115-b to release a network connection (e.g., RRC connection) and suppress reconnection to the wireless communication network for the time period corresponding to the session interval.

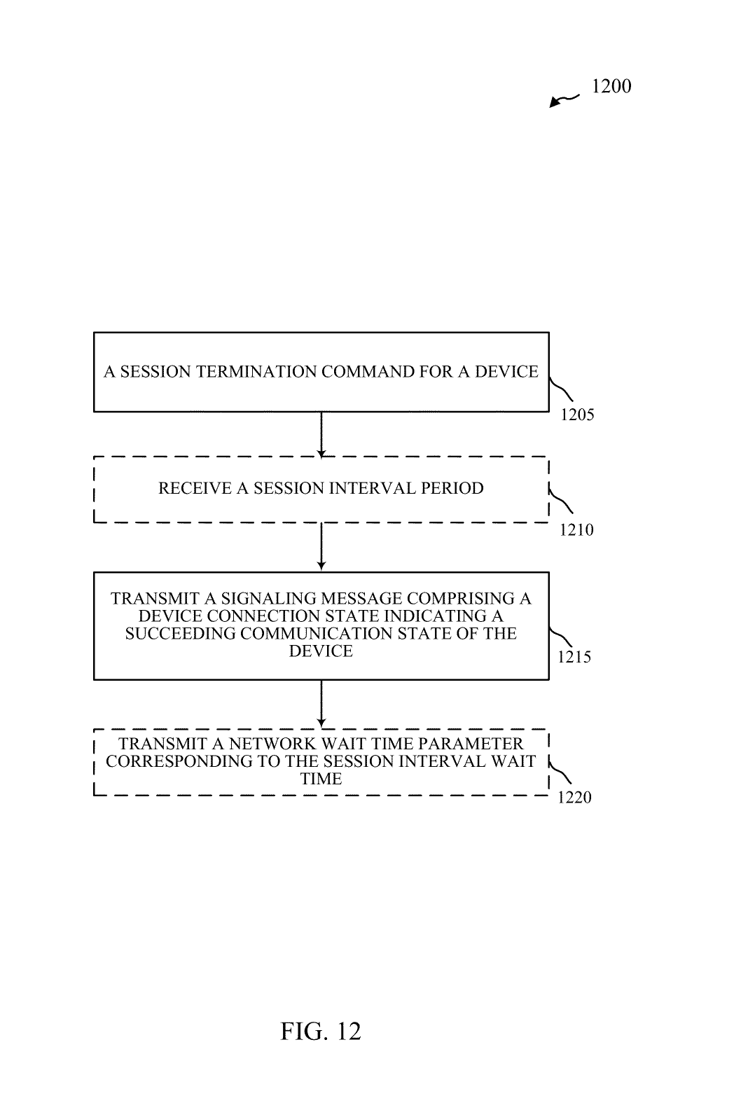

FIG. 12 is a flow chart illustrating a method 1200 for network directed device session control according to an aspect of the present disclosure. In one configuration, the method 1200 is described below with reference to an MTC IWF entity. However, the method may be performed by other entities of a core network supporting network directed device session control.

At block 1205, an MTC IWF receives a session termination command for a device. The session termination command includes a session indicator. For example, the MTC IWF may receive the session termination command from an MTC server that indicates whether a currently attached device, such as an MTC device, should be online and available for mobile terminated communications (e.g., paging, etc.) during a succeeding time period or offline and not available. At block 1210, a session interval period may also be received in the session termination command. The session interval period may indicate the time period until the next communication session of the device.

At block 1215, the MTC IWF may transmit a signaling message comprising a device connection state indicating a succeeding communication state of the device. The device connection state may be based on the session indicator. At block 1220, the MTC IWF may transmit, in the signaling message, a network wait time parameter corresponding to the session interval wait time.

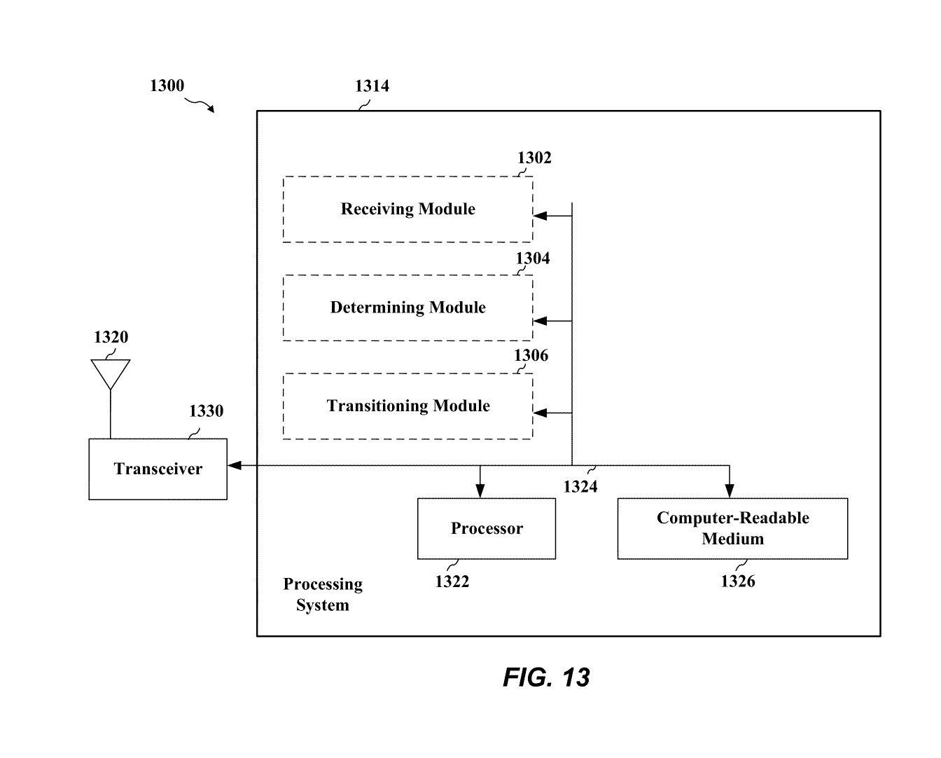

FIG. 13 is a diagram illustrating an example of a hardware implementation for an apparatus 1300 employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1322 the modules 1302, 1304, 1306 and the computer-readable medium 1326. The bus 1324 may also link various other circuits such as timing sources, peripherals, voltage regulators, and power management circuits, which are well known in the art, and therefore, will not be described any further.

The apparatus includes a processing system 1314 coupled to a transceiver 1330. The transceiver 1330 is coupled to one or more antennas 1320. The transceiver 1330 enables communicating with various other apparatus over a transmission medium. The processing system 1314 includes a processor 1322 coupled to a computer-readable medium 1326. The processor 1322 is responsible for general processing, including the execution of software stored on the computer-readable medium 1326. The software, when executed by the processor 1322, causes the processing system 1314 to perform the various functions described for any particular apparatus. The computer-readable medium 1326 may also be used for storing data that is manipulated by the processor 1322 when executing software.

The processing system 1314 includes a receiving module 1302 for receiving a signaling message from a wireless communication network comprising a session interval and a device connection state indicator. The processing system 1314 also includes a determining module 1304 for determining a device connection state based at least in part on the device connection state indicator. The processing system 1314 may further include a transitioning module 1306 for transitioning to the device connection state for a time period corresponding to the session interval. The modules may be software modules running in the processor 1322, resident/stored in the computer-readable medium 1326, one or more hardware modules coupled to the processor 1322, or some combination thereof. The processing system 1314 may be a component of the MTC device 900 and/or the device 115-f and may include the processor 1080 and/or the memory 1082.

In one configuration, the device 115-f and/or MTC device 900 is configured for wireless communication including means for receiving. In one aspect, the receiving means may be the receiving module 1302, processor 1322, 1080, antenna 1052, modulator/demodulator 1054, receiver processor 1058, memory 980, transceiver module 950, processor module 970, and/or antenna(s) 945 configured to perform the functions recited by the receiving means. The device 115-f and/or MTC device 900 is also configured to include a means for determining and means for transitioning. In one aspect, the determining means and/or transitioning may be the processor 1322, 1080, determining module 1304, transitioning module 1306, memory 980, and/or processor module 970 configured to perform the functions recited by the transitioning means and/or the determining means. In another configuration, the aforementioned means may be any module or any apparatus configured to perform the functions recited by the aforementioned means.

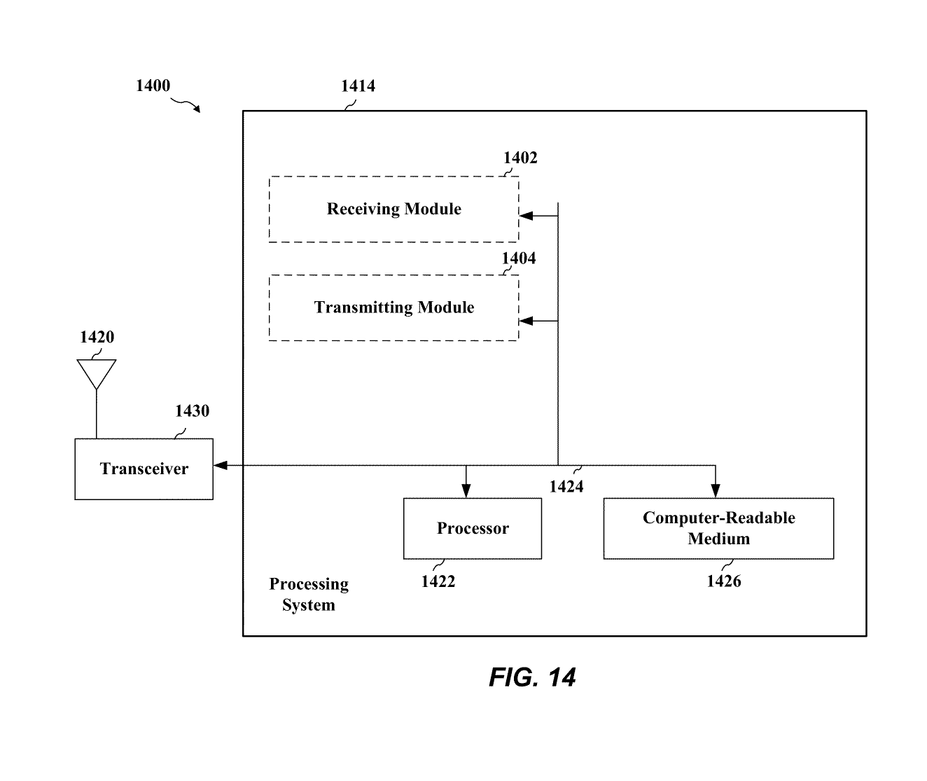

FIG. 14 is a diagram illustrating an example of a hardware implementation for an apparatus 1400 employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1422, the modules 1402, 1404 and the computer-readable medium 1426. The bus 1424 may also link various other circuits such as timing sources, peripherals, voltage regulators, and power management circuits, which are well known in the art, and therefore, will not be described any further.

The apparatus includes a processing system 1414 coupled to a transceiver 1430. The transceiver 1430 is coupled to one or more antennas 1420. The transceiver 1430 enables communicating with various other apparatus over a transmission medium. The processing system 1414 includes a processor 1422 coupled to a computer-readable medium 1426. The processor 1422 is responsible for general processing, including the execution of software stored on the computer-readable medium 1426. The software, when executed by the processor 1422, causes the processing system 1414 to perform the various functions described for any particular apparatus. The computer-readable medium 1426 may also be used for storing data that is manipulated by the processor 1422 when executing software.

The processing system 1414 includes a receiving module 1402 for receiving a session termination command for a device. The processing system 1414 also includes a transmitting module 1404 for transmitting a signaling message comprising at least a device connection state indicating a succeeding communication state of the device. The modules may be software modules running in the processor 1422, resident/stored in the computer-readable medium 1426, one or more hardware modules coupled to the processor 1422, or some combination thereof. The processing system 1414 may be a component of the base station 105-c and may include the processor 1040 and/or the memory 1042.

In one configuration, the base station 105-c is configured for wireless communication including means for receiving. In one aspect, the receiving_means may be the receiving module 1402, processor 1422, 1040, antenna 1034, modulator 1032, receiver processor 1038, and/or memory 1042 configured to perform the functions recited by the receiving means. The base station 105-c is also configured to include a means for transmitting. In one aspect, the transmitting means may be the transmitting module 1404, processor 1040, 1422, antenna 1034, modulator 1032, and/or transmitter processor 1020 configured to perform the functions recited by the transmitting means. In another configuration, the aforementioned means may be any module or any apparatus configured to perform the functions recited by the aforementioned means.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software, or combinations thereof. If implemented in software, the functions may be stored on or transmitted over as one or more instructions or code on a computer-readable medium. Other examples and implementations are within the scope and spirit of the disclosure and appended claims. For example, due to the nature of software, functions described above can be implemented using software executed by, e.g., a processor, hardware, hardwiring, or combinations thereof. Features implementing functions may also be physically located at various positions, including being distributed such that portions of functions are implemented at different physical locations. Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, PCM (phase change memory), CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray™ disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method comprising:
receiving, at a device, a signaling message from a wireless communication network comprising a session interval and a device connection state indicator;
determining a device connection state based at least in part on the device connection state indicator; and
transitioning to the device connection state for a time period corresponding to the session interval.

2. The method of claim 1, further comprising detaching from the wireless communication network for the time period corresponding to the session interval when the device connection state indicates a detached communication state.

3. The method of claim 2, in which the detaching is performed without signaling the detaching to the wireless communication network.

4. The method of claim 2, further comprising reattaching, subsequent to the time period corresponding to the session interval, to the wireless communication network.

5. The method of claim 1, further comprising transitioning at least a portion of a radio subsystem of the device to a low power communication state based on the determined device connection state.

6. The method of claim 1, in which the signaling message further comprises a detach request.

7. The method of claim 1, in which the signaling message further comprises a radio resource control connection release message.

8. The method of claim 1, further comprising releasing a network connection to the wireless communication network for the time period corresponding to the session interval when the device connection state indicates a communication standby state.

9. The method of claim 8, further comprising receiving, during the time period corresponding to the session interval, paging information on a paging channel of the wireless communication network.

10. The method of claim 8, further comprising reconnecting, subsequent to the time period corresponding to the session interval, to the wireless communication network.

11. The method of claim 10, further comprising initiating, prior to reconnecting to the wireless communication network, an event measurement capturing event information to be transmitted to the wireless communication network upon reconnection.

12. A method comprising:
receiving a session termination command for a device, the session termination command comprising a session indicator; and
transmitting, to the device, a signaling message comprising at least a device connection state indicating a succeeding communication state of the device, the device connection state based at least in part on the session indicator.

13. The method of claim 12, in which:
the session termination command further comprises a session interval period; and
the signaling message further comprises a wait time parameter corresponding to the session interval period.

14. The method of claim 13, further comprising determining that the device will not receive communications during the session interval period based on the session indicator, in which the signaling message further comprises a network detach request.

15. The method of claim 13, further comprising determining that the device should receive communications during the session interval period, in which the signaling message further comprises a network connection release message.

16. An apparatus for wireless communication, the apparatus comprising:
a memory unit; and
at least one processor coupled to the memory unit; the at least one processor being configured:
to receive, at a device, a signaling message from a wireless communication network comprising a session interval and a device connection state indicator;
to determine a device connection state based at least in part on the device connection state indicator; and
to transition to the device connection state for a time period corresponding to the session interval.

17. The apparatus of claim 16, in which the at least one processor is further configured to detach from the wireless communication network for the time period corresponding to the session interval when the device connection state indicates a detached communication state.

18. The apparatus of claim 17, in which the at least one processor is further configured to detach without signaling the detaching to the wireless communication network.

19. The apparatus of claim 17, in which the at least one processor is further configured to reattach, subsequent to the time period corresponding to the session interval, to the wireless communication network.

20. The apparatus of claim 16, in which the at least one processor is further configured to transition at least a portion of a radio subsystem of the device to a low power communication state based on the determined device connection state.

21. The apparatus of claim 16, in which the signaling message further comprises a detach request.

22. The apparatus of claim 16, in which the signaling message further comprises a radio resource control connection release message.

23. The apparatus of claim 16, in which the at least one processor is further configured to release a network connection to the wireless communication network for the time period corresponding to the session interval when the device connection state indicates a communication standby state.

24. The apparatus of claim 23, in which the at least one processor is further configured to receive, during the time period corresponding to the session interval, paging information on a paging channel of the wireless communication network.

25. The apparatus of claim 23, in which the at least one processor is further configured to reconnect, subsequent to the time period corresponding to the session interval, to the wireless communication network.

26. The apparatus of claim 25, in which the at least one processor is further configured to initiate, prior to reconnecting to the wireless communication network, an event measurement capturing event information to be transmitted to the wireless communication network upon reconnection.

27. An apparatus for wireless communication, the apparatus comprising:
a memory unit; and
at least one processor coupled to the memory unit; the at least one processor being configured:
to receive a session termination command for a device, the session termination command comprising a session indicator; and
to transmit, to the device, a signaling message comprising at least a device connection state indicating a succeeding communication state of the device, the device connection state based at least in part on the session indicator.

28. The apparatus of claim 27, in which:
the session termination command further comprises a session interval period; and
the signaling message further comprises a wait time parameter corresponding to the session interval period.

29. The apparatus of claim 28, in which the at least one processor is further configured to determine that the device will not receive communications during the session interval period based on the session indicator, in which the signaling message further comprises a network detach request.

30. The apparatus of claim 28, in which the at least one processor is further configured to determine that the device should receive communications during the session interval period, in which the signaling message further comprises a network connection release message.

31. An apparatus for wireless communication, the apparatus comprising:
means for receiving, at a device, a signaling message from a wireless communication network comprising a session interval and a device connection state indicator;
means for determining a device connection state based at least in part on the device connection state indicator; and
means for transitioning to the device connection state for a time period corresponding to the session interval.

32. The apparatus of claim 31, further comprising means for detaching from the wireless communication network for the time period corresponding to the session interval when the device connection state indicates a detached communication state.

33. The apparatus of claim 32, in which the detaching is performed without signaling the detaching to the wireless communication network.

34. The apparatus of claim 32, further comprising means for reattaching, subsequent to the time period corresponding to the session interval, to the wireless communication network.

35. The apparatus of claim 31, further comprising means for transitioning at least a portion of a radio subsystem of the device to a low power communication state based on the determined device connection state.

36. The apparatus of claim 31, in which the signaling message further comprises a detach request.

37. The apparatus of claim 31, in which the signaling message further comprises a radio resource control connection release message.

38. The apparatus of claim 31, further comprising means for releasing a network connection to the wireless communication network for the time period corresponding to the session interval when the device connection state indicates a communication standby state.

39. The apparatus of claim 38, further comprising means for receiving, during the time period corresponding to the session interval, paging information on a paging channel of the wireless communication network.

40. The apparatus of claim 38, further comprising means for reconnecting, subsequent to the time period corresponding to the session interval, to the wireless communication network.

41. The apparatus of claim 40, further comprising means for initiating, prior to reconnecting to the wireless communication network, an event measurement capturing event information to be transmitted to the wireless communication network upon reconnection.

42. An apparatus for wireless communication, the apparatus comprising:
means for receiving a session termination command for a device, the session termination command comprising a session indicator; and
means for transmitting, to the device, a signaling message comprising at least a device connection state indicating a succeeding communication state of the device, the device connection state based at least in part on the session indicator.

43. The apparatus of claim 42, in which:
the session termination command further comprises a session interval period; and
the signaling message further comprises a wait time parameter corresponding to the session interval period.

44. The apparatus of claim 43, further comprising means for determining that the device will not receive communications during the session interval period based on the session indicator, in which the signaling message further comprises a network detach request.

45. The apparatus of claim 43, further comprising means for determining that the device should receive communications during the session interval period, in which the signaling message further comprises a network connection release message.

46. A computer program product for wireless communications, the computer program product comprising:
a non-transitory computer-readable medium having program code recorded thereon, the program code comprising:
program code to receive, at a device, a signaling message from a wireless communication network comprising a session interval and a device connection state indicator;
program code to determine a device connection state based at least in part on the device connection state indicator; and
program code to transition to the device connection state for a time period corresponding to the session interval.

47. A computer program product for wireless communications, the computer program product comprising:
a non-transitory computer-readable medium having program code recorded thereon, the program code comprising:
program code to receive a session termination command for a device, the session termination command comprising a session indicator; and
program code to transmit, to the device, a signaling message comprising at least a device connection state indicating a succeeding communication state of the device, the device connection state based at least in part on the session indicator.
